(19) United States
(12) Patent Application Publication
(10) Pub. No.: US 2005/0117552 A1
(43) Pub. Date: Jun. 2, 2005

(54) Device and method for performing page scan on a communication channel

(76) Inventor: Soeren Mikkelsen, Aabybro (DK)

Correspondence Address: Bell, Boyd & Lloyd LLC, P.O. Box 1135, Chicago, IL, 60690-1135, US

(21) Appl. No.: 11/004,324

(22) Filed: Dec. 2, 2004

(30) Foreign Application Priority Data
Dec. 2, 2003 (EP) 03027642.2

(51) Int. Cl. H04J 3/00

(52) U.S. Cl. 370/336; 340/825.2

(57) ABSTRACT

A device and method for performing page scan on a first communication channel by listening to the first communication channel, which includes set-up parts for performing a page scan on the first communication channel, a first timer for defining a first time interval between successive page scans, a second timer for defining a second time interval between successive page scans, where the second interval is shorter than the first interval, wherein the set-up parts are responsive to second channel communication parts and are adapted to use the second timer when a connection on the second channel is being initiated in the device, and to use the first timer when the connection on the second communication channel has been initiated.

### BACKGROUND OF THE INVENTION

The present invention relates to performing page scan on a physical channel by listening to it.

The recent development in mobile communications has significantly increased the versatility of subscriber terminals. A subscriber terminal has constantly been evolving from a mobile phone towards an intelligent device, providing the subscriber with a variety of services.

The developments in local communication options, especially in those utilizing low power radio frequency communications, have lead to an increasing choice of different peripherals or accessories being wirelessly connectable to the subscriber terminals. A remarkable market share of such local communication options has been obtained by Bluetooth devices. An example of such a peripheral or accessory is a wireless headset. In order to be able to communicate with the subscriber terminal, the headset has to have a connection with the subscriber terminal.

One way to establish a connection between a peripheral or accessory and the subscriber terminal is that the subscriber terminal is slave and the accessory or peripheral is master. Using the wireless headset as an example, the details for the establishment of a Bluetooth connection can be found in the Bluetooth standard; e.g., in Bluetooth specification 1.2. In the standard there is defined how the slave has to perform a page scan on a physical channel by listening to it, and how it should respond to the page detected.

As noted in the referred version of the specification, in choosing the manner in which the page scan is performed, a trade-off between current consumption and fast connection set-up has to be performed.

It has turned to be particularly problematic in a subscriber terminal to use the fast connection set-up, because of the larger current consumption which has always been a problem in a mobile device getting its operating power from a rechargeable battery. However, using the slow connection set-up would in some cases be particularly annoying to the user. In some cases, the slow connection set-up might even lead to missing another connection, if the accessory or peripheral is used on a first communication channel to command the subscriber terminal to accept a connection on a second communication channel.

A rather good introduction to the technical background of connection set-up related page and page scan procedures in Bluetooth ad-hoc wireless networks can be found in published US patent application 2003/0012173 A1.

### SUMMARY OF THE INVENTION

The present invention is therefore directed toward improving a device and method for performing page scan on a first communication channel by listening to it.

By selecting a shorter interval between two page scans when a connection on the second communication channel is being initiated, and a longer interval between two page scans after the connection on the second communication channel has been initiated, the average time for a connection set-up on a first communication channel can be shortened, in cases when a connection on the second communication channel is being initiated. This may result in enabling a faster connection set-up and consuming less current.

By doing this, current consumption outside the initiation of a connection on the second communication channel can be reduced from the magnitude it would have if the shorter intervals were also used in these instances.

An example of such initiating of a connection on the second communication channel is an incoming call from the cellular network. A possible use case is establishing a connection between a wireless headset and a subscriber terminal.

Additional features and advantages of the present invention are described in, and will be apparent from, the following Detailed Description of the Invention and the Figures.

### BRIEF DESCRIPTION OF THE FIGURES

FIG. 1 shows a block diagram of a subscriber terminal wirelessly connectable to an accessory or a peripheral via a first connection channel CH1 and to a cellular network via a second communication channel CH2.

FIG. 2 is a flow diagram showing an example of including the changing of a timer used in performing page scan.

### DETAILED DESCRIPTION OF THE INVENTION

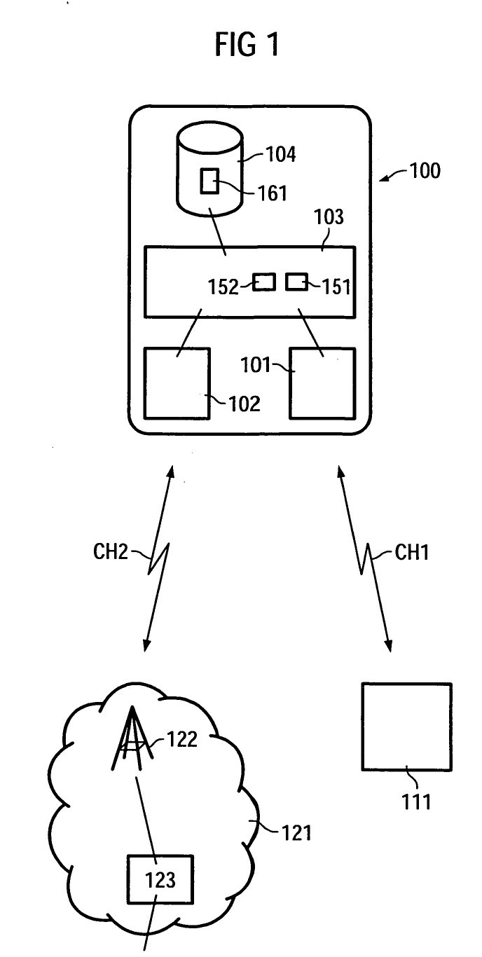

FIG. 1 shows a block diagram of a subscriber terminal 100 wirelessly connectable to an accessory or a peripheral 111 via a first connection channel CH1 and to a cellular network 121 via a second communication channel CH2.

The subscriber terminal 100 is wirelessly connectable to a peripheral or an accessory 111, such as a wireless headset. Therefore, the subscriber terminal 100 includes communication parts 101 for communication with the peripheral or accessory 111 over a first communication channel CH1. Preferably, the first connection channel CH1 is a local communication channel, such as a Bluetooth communication channel. In the Bluetooth communication channel, the communications are performed using a low-power radio frequency transmitter-receivers. In the following description it is assumed that the communication channel CH1 is a Bluetooth communication channel.

Further, the subscriber terminal 100 includes communication parts 102 for communication with the cellular network 121 over a second communication channel CH2. In particular, the subscriber terminal 100 can be in connection with an element 123, such as a gateway or a switching center 123 in the cellular network 121 via a base station 122. The communication between the cellular network 121 and the subscriber terminal 100 takes place over a second communication channel CH2. The second communication channel CH2 may be as defined in any one of the relevant standards; in particular for GSM, GPRS, or UMTS. Typically, communications on the communication channel CH2 is performed in the microwave frequency range.

The subscriber terminal further includes a central unit 103 and memory 104. According to a first embodiment of the present invention, in the central unit there are defined the first timer 151 and the second timer 152. The first and second timers 151, 152 are intended for defining intervals between two page scans. The first timer 151 defines a first interval T_{GAP} (108), whereas the second timer 152 defines a second interval T_{GAP} (106).

For a Bluetooth device, the most advantageous value for the second interval T_{GAP} (106) is approximately 100 ms, and for the first interval T_{GAP} (108) approximately 2.56 seconds. These values have been specified in BLUETOOTH SPECIFICATION, Version 1.2 [vol 3] as timer values for Interlaced scans. Of course, other suitable values for the first and second intervals T_{GAP} (108), T_{GAP} (106) can be used as well.

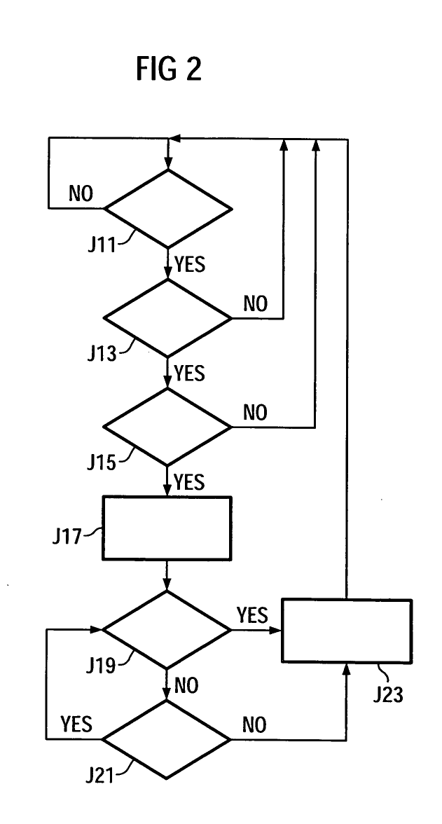

FIG. 2 is a flow diagram showing an example including the changing of a timer used in performing page scan.

In step J11, it is tested by the central unit 103 whether or not there is an incoming call. Because the central unit 103 controls communication parts 102 for communication with the cellular network 121 over the second communication channel CH2, it can detect when the cellular network 121 is paging the subscriber terminal 100.

If there is an incoming call, then in step J13 it is checked whether the using of communication parts 101 for communication with the peripheral or accessory 111 over a first communication channel CH1 is enabled. If it is not enabled, the control is returned to step J11.

In step J15 it is checked whether an entry 161 showing that an accessory or peripheral 111 is present has been previously defined. Preferably, this entry 161 is stored in the memory 104. If the entry 161 has not been defined, the control is returned to step J11.

In step J17, the fast connection setup is enabled. In other words, the second timer 152 for defining a second interval T_{GAP} (106) between two page scans is selected to be used in the communication parts 101 for communication with the peripheral or accessory 111 over the first communication channel CH1.

In step J19 it is checked whether the incoming call has been accepted or a hands-free connection established. In a positive case, in step J23 the fast connection setup is disabled. In other words, in step J23 the first timer 151 for defining a first interval T_{GAP} (108) between two page scans is selected to be used in the communication parts 101 for communication with the peripheral or accessory 111 over the first communication channel CH1. After step J23, the control is returned to step J11.

In the opposite case, that is if the incoming call has not been accepted nor a hands-free connection established, in step J21 it is checked whether the incoming call is still ringing. If the incoming call is not ringing anymore, the control is passed to step J23 where the fast connection setup is disabled. If the incoming call is still ringing, the control is passed back to step J19.

In order to ensure that the user of the peripheral or accessory 111 only gets connected to the right subscriber terminal 100 and not to another subscriber terminal in the area, the entry 161 may identify the peripheral or accessory 111 that correspond to the subscriber terminal 100. Further, in the peripheral or accessory 111, there may be a similar entry identifying the right subscriber terminal 100 corresponding to the peripheral or accessory 111. In this manner, the peripheral or accessory 111 can be in a standby mode having a very low power consumption. In such a mode, the peripheral or accessory 111 is powered on but has no Bluetooth connection.

In the example of a wireless headset, when the subscriber terminal 100 is paging the user (i.e., ringing), the user can hear the ringing tone and pick up the headset and then push the accept call button. At that time, the headset tries to establish the connection and to accept the call.

Using the faster connection set-up, a connection on the first communication channel CH1 can be performed approximately about 65% faster than using a normal connection set-up.

The skilled person appreciates that the present invention is not limited by the examples of using a GSM or UMTS subscriber terminal for receiving a call. Indeed, although the present invention has been described with reference to specific embodiments, those of skill in the art will recognize that changes may be made thereto without departing from the spirit and scope of the present invention as set forth in the hereafter appended claims.

1. A device for performing page scan on a first communication channel by listening to the first communication channel, comprising:
set-up parts for performing a page scan on the first communication channel;
a first timer for defining a first time interval between successive page scans; and
a second timer for defining a second time interval between successive page scans, where the second time interval is shorter than the first time interval;
wherein: the set-up parts are responsive to second channel communication parts and are adapted to use the second timer when a connection on a second channel is being initiated in the device, and to use the first timer when the connection on the second communication channel has been initiated.

2. A device for performing page scan on a first communication channel as claimed in claim 1, wherein the communication channel is a local communication channel, and the second communication channel is a cellular radio communication channel.

3. A device for performing page scan on a first communication channel as claimed in claim 2, wherein the local communication channel is a Bluetooth communication channel.

4. A device for performing page scan on a first communication channel as claimed in claim 3, wherein the first time interval is approximately 2.56 seconds.

5. A device for performing page scan on a first communication channel as claimed in claim 3, wherein: the second time interval is approximately 100 milliseconds.

6. A device for performing page scan on a first communication channel as claimed in claim 1, wherein the set-up parts are further adapted to one of perform the page scan only when an entry showing that an accessory device is present has been previously defined, and inhibit performing the page scan when an entry showing that an accessory device is present has not been previously defined.

7. A device for performing page scan on a first communication channel as claimed in claim 6, wherein the device is a subscriber terminal of a cellular network and the accessory device is a wireless headset.

8. A method for performing page scan on a first communication channel by listening to the first communication channel, the method comprising:
defining, via a first timer of a device, a first time interval between successive page scans when a connection on a second communication channel is being initiated; and
defining, via a second timer of the device, a second time interval, which is longer than the first time interval, between successive page scans after the connection on the second communication channel has been initiated.

9. A method for performing page scan on a first communication channel as claimed in claim 8, wherein of claim 8, wherein the first communication channel is a local communication channel and the second communication channel is a cellular radio communication channel.

10. A method for performing page scan on a first communication channel as claimed in claim 9, wherein the local communication channel is a Bluetooth communication channel.

11. A method for performing page scan on a first communication channel as claimed in claim 10, wherein the first time interval is approximately 100 milliseconds.

12. A method for performing page scan on a first communication channel as claimed in claim 10, wherein the second time interval is approximately 2.56 seconds.

13. A method fir performing page scan on a first communication channel as claimed in claim 8, wherein the page scan on the first communication channel is performed responsively to a second communication channel only if an entry showing that an accessory device is present has been previously defined.
